(19) United States
(12) Patent Application Publication
(10) Pub. No.: US 2025/0322290 A1
(43) Pub. Date: Oct. 16, 2025

(54) Systems and Methods for Discovering New Gameplay Techniques Using Reinforcement Learning

(71) Applicant: Sony Interactive Entertainment Inc., Tokyo (JP)

(72) Inventor: Ayush Raina, San Francisco, CA (US)

(21) Appl. No.: 18/633,377

(22) Filed: Apr. 11, 2024

(51) Int. Cl. G06N 20/00; A63F 13/67

(52) U.S. Cl. CPC G06N 20/00; A63F 13/67

(57) ABSTRACT

Exemplary embodiments include reinforcement learning systems and methods for discovering new techniques for playing a game. An exemplary system comprises: A determining agent configured to search at least one Internet platform for data related to a game scenario and determine at least one reward framework based on results from the search of the Internet platform, the reward framework being determined by at least one metric for a characteristic of the game scenario; and a reinforcement learning agent configured to perform a training and exploration loop comprising a plurality of iterations, each iteration comprising: playing at least one game scenario within a game by taking sequential in-game actions available in the game scenario; transmitting results of each of the plurality of sequential in-game actions to the determining agent; and receiving a reward for successful progression through the game scenario according to the reward framework determined by the determining agent.

### FIELD OF THE TECHNOLOGY

Embodiments of the disclosure relate to machine learning techniques and, in particular, to reinforcement learning techniques for discovering and evaluating techniques within a gaming environment.

### SUMMARY OF EXEMPLARY EMBODIMENTS

Embodiments of the disclosure include systems and methods for system for discovering at least one new technique for playing a game, the system comprising: a determining agent comprising at least one processor and at least one memory storing instructions which, when executed by the at least one processor, cause the processor to: search at least one Internet platform for data related to at least one game scenario; and determine at least one reward framework based on results from the search of the at least one Internet platform, the at least one reward framework being determined by at least one metric for a characteristic of the at least one game scenario; and a reinforcement learning agent configured to perform a training and exploration loop comprising a plurality of iterations, each of the plurality of iterations comprising: playing the at least one game scenario within a game, the playing comprising taking a plurality of sequential in-game actions available in the at least one game scenario; transmitting results of each of the plurality of sequential in-game actions to the determining agent; and receiving a reward for successful progression through the at least one game scenario according to at least one reward framework determined by the determining agent, the reward comprising a quantitative score.

In some embodiments, the determining agent is further configured to: determine an optimal sequence of in-game actions for the at least one game scenario based on a plurality of scores comprising each of the quantitative scores from each of the plurality of iterations.

In some embodiments, the at least one Internet platform comprises any one of: a video streaming platform, a game developer website, an Internet forum, a game wiki, and a news source.

In some embodiments, the characteristic of the at least one game scenario is any one of: level of difficulty or skill of the at least one game scenario; novelty of the in-game action or the sequence of actions; surprise due to a result of the action or the sequence of actions; popularity of the in-game action or sequence of actions; humor due to the result of the action or the sequence of actions; and enjoyment of the result of the action or sequence of actions.

In some embodiments, the at least one metric for the characteristic is any one of: frequency of a key word or phrase associated with the at least one in-game scenario; image data from image stills or video frames associated with the at least one in-game scenario; a trendline indicating a change in the frequency with which the key word or phrase are used; and game data from networked games indicating the frequency with which the action or the sequence of actions are used in the in-game scenario.

In some embodiments, the system further comprises a memory storage for storing a sequence of game states, the actions and the sequence of actions, and information associated with the metrics for the at least one characteristic of the in-game scenario.

In some embodiments, the system further comprises a filtering agent configured to determine optimal metas, policies, and strategies for the in-game actions as defined by the at least one metric for the characteristic.

In some embodiments, the determining agent further comprises a deep neural network having an input layer, a plurality of hidden layers, and an output layer, the plurality of hidden layers being configured to process input received at the input layer and transmit a first output to the output layer, the plurality of hidden layers being trained and tuned using weights and biases for optimal results based on the at least one metric for the characteristic.

In some embodiments, the determining agent is further configured to share results from the plurality of iterations with a network of users and evaluate subsequent trends related to the results.

Further disclosed are embodiments for methods of making, implementing, and using the various system embodiments described herein. Further disclosed are non-transitory computer-readable storage media having instructions which, when executed, perform the steps of the various methods described herein.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 diagrammatically illustrates an exemplary method for implementing an RL agent to discover metas, policies, and strategies.

FIG. 2 shows an exemplary method of configuring metrics for a reward model based on Internet data.

FIG. 3 shows an exemplary deep neural network.

### DETAILED DESCRIPTION OF EXEMPLARY EMBODIMENTS

As used herein, a “meta” generally refers to a gaming tactic. Examples include approaches to solving in-game problems, such as puzzles, fight sequences, or one or more obstacles in a game. Unless context indicates otherwise, a “meta” specifically refers to a specific tactic employed during a specific sequence within a game.

Context herein may indicate that the terms “meta,” “policy”, and “strategy” are interchangeable. However, unless context indicates otherwise, a “policy” is a way of approaching a similar type of problem throughout a game, while “strategy” generally refers to a collection of metas and policies used to achieve one or more goals throughout a game. “Gameplay technique” and “technique for playing a game” generally refer to any one of a meta, policy, or strategy.

As used herein, “reinforcement learning” (RL) is an area of machine learning concerned with how an intelligent agent ought to take actions in a dynamic, stochastic environment in order to maximize the cumulative reward.

The environment for RL can be modeled as a Markov Decision Process (MDP) because many RL algorithms use dynamic programming techniques. However, RL algorithms do not assume knowledge of an exact mathematical model of the MDP.

RL works in a mathematical framework comprising: A state space or observation space comprising all available information and problem features that are useful for making a decision (including fully known or measured variables as well as unmeasured variables for which one might only have a belief or estimate); an action space comprising the decisions that can be taken in each state of the system; and a reward signal comprising a scalar signal that provides the necessary feedback about the performance, and therefore the opportunity to learn which actions are beneficial in any given state. RL agents can be implemented using artificial intelligence technologies such as Deep Neural Networks.

Professional gamers, including streamers on platforms such as YouTube or Twitch, enjoy figuring out new metas, policies, and strategies, and sharing their findings with other members of gaming communities. Discovery of a new meta can be an exciting and engaging experience, as newly discovered metas may be visually appealing and entertaining and may help players advance more quickly through a game.

However, in the vast universe of video and online games, there are innumerable metas to be discovered. A solution is desired to determine previously unknown metas in real time, and further, to gauge whether such newly discovered metas will be well-received.

Embodiments of the disclosure herein relate to the use of machine learning, and in particular to reinforcement learning, to determine popular metas.

In some embodiments, the method takes a two-pronged approach. The first prong uses a determining agent to obtain Internet results pertaining to game metas, policies, and strategies. The second prong employs a deep reinforcement learning agent to play through a game to test for optimal metas, policies, and strategies within the game.

First, a determining agent receives existing data from available sources, the data generally pertaining to one or more games and metas, strategies, and policies within the one or more games. Available sources generally include streaming platforms; tutorial videos and gaming highlights on video-streaming platforms; forums and message boards; game wikis; news outlets, and other Internet platforms. The determining agent searches through the available source data and evaluates the source data for information that would be useful to the player, such as new aspects that are indicative of undiscovered metas, policies, or strategies.

In some embodiments, the determining agent comprises a server having a processor and memory, the memory having instructions stored thereon which, when executed, cause the server to perform a search of one or more platforms over a network for content related to a videogame and to store common terms, key words, key phrases, or other data related to the game. The sources for such terms generally include streaming platforms having video descriptions, video transcripts, viewer comments, as well as forums and message boards, game developer pages and game wikis, and news outlets and blogs. In some embodiments, further data is collected, such as image data from game stills or video frames and associated metadata. In some embodiments, data is collected from networked games in which the frequency of use of an in-game action or sequence of actions can be tracked and determined directly.

It should be noted that multi-modal inputs can be used where, for example, both real-time speech-to-text recognition and pre-prepared video transcripts are received.

In some embodiments, the search comprises a narrow approach toward specific levels, missions, objectives, or quests within a game. In some embodiments, the search results are ranked according to various metrics or reward frameworks, including level of performance or skill; novelty; surprise or shock; popularity; humor; and enjoyment. In some embodiments, confidence scoring is used to determine the rankings of results. Accordingly, users are enabled to filter results for a preferred reward framework during a gaming session. For example, a user may sort by popularity to test a common and enjoyable meta, or they may sort by novelty to attempt an uncommon and possibly under-discovered one.

In some embodiments, the determining agent further comprises one or more deep neural networks, each deep neural network having an input layer, a plurality of hidden layers, and an output layer. The hidden layer is configured to receive input comprising the results of a search. The plurality of hidden layers is configured to process the input received at the input layer and is trained and tuned with weights and biases for optimal results based on the one or more metrics or reward frameworks. The plurality of hidden layers transmits a first output to the output layer. In some embodiments, the first output is transferred to the input layer as input.

In the second prong, a deep reinforcement learning (RL) agent is configured to play a particular game. In the course of gameplay, the RL agent evaluates what possible actions can be taken. In some embodiments, the RL agent initially attempts to play the game using random actions to determine possible ways to progress through a game scenario. With recursive plays, the RL agent obtains available metas based on actions it has taken and, accordingly, develops policies for what actions to take and when to take each particular action. Effectively, as the game progresses, the RL agent uses reinforcement learning to determine how to play the game.

In some embodiments, the RL agent uses a reward system, whereby if the agent makes a correct decision with which it progresses through the game, the RL agent receives a +1 score, whereas if the RL agent makes an incorrect decision, it receives a −1 score. These scores are exemplary, and may be adjusted or scaled appropriately, including by linear, exponential, and logarithmic scaling.

Generally, an incorrect decision leads to a character's reduced health or hit points, a character's in-scene death or knock-out, loss of a round, or failure of a level, mission, or quest. A correct decision generally comprises a successful step toward solving a puzzle, a successful strike against an enemy or defeat of an enemy, or successful progress or completion of a level, round, or quest.

The RL agent plays multiple iterations of the same scenarios within the game, and after many iterations, the RL agent determines which actions in the various scenarios are ineffective, which are good, which are better, and which are optimal. Accordingly, the RL agent determines available methods for obtaining metas throughout a game.

It should be noted that the RL agent does not need labelled input/output pairs to be presented and does not need sub-optimal actions to be explicitly corrected.

Further, in some embodiments, the RL agent receives multi-dimensional awards for actions taken throughout a game. In some such embodiments, the RL agent receives a reward for characteristics determined from the determining agent's metrics and reward frameworks, including level of skill, novelty, surprise, popularity, humor, and enjoyment.

In some embodiments, the metas, strategies, and policies discovered by the RL model are communicated to the determining agent, which compares the RL agent's results to known information and data for aspects such as popularity or novelty of the discovered metas, policies, and strategies. For example, the determining agent may compare one meta obtained from the RL agent with web results to find that it has many returns across the web and is particularly popular and utilized on one streaming platform. Alternatively, the model may find that a second meta is relatively unknown, having few returns on any platform.

In some embodiments, the determining agent also evaluates trendlines for various metas, such as when metas were popular and whether newly popular metas are emerging, and which platforms are seeing which trends. Accordingly, a user is enabled to implement newly trending metas discovered by the RL agent, or previously unknown metas newly discovered by the RL agent, per the user's preference.

In some embodiments, the determining agent shares metas obtained from the RL agent on any of the various online platforms and measures the response. In some such embodiments, the determining agent evaluates trendlines for shared metas and uses the trendlines to evaluate for overall popularity, sharp or gradual increases in popularity, and for content indicative of its surprise value, humor, difficulty, and overall enjoyment.

In some embodiments, determination of trends for the metas includes video viewership data; video reaction or “like” data, including reactions in proportion to views, positive reactions relative to negative reactions, and total reactions; share count; and similar metrics.

In some embodiments, overall enjoyment is determined at least in part by how many people are playing a given scenario and whether they are using similar strategies. For example, in some embodiments in which the determining agent shares the newly discovered metas, the determining agent also evaluates how many players have are using strategies similar to one or more of those that have been shared.

In some embodiments, “surprise” comprises an unexpected action or unexpected result from an action. Using input data from Internet sources, the determining agent predicts which actions are most expected in a given game scenario. In some embodiments, expected actions are the most common or most often suggested actions in the given scenario. In some embodiments in which the RL agent is set to determine the most surprising actions and results, the RL agent is rewarded for taking actions that allow it to successfully progress through the game, but it is rewarded more greatly for taking actions that yield unexpected, successful results.

In some embodiments, the reward mechanism is tuned according to a strategy desired by the user. In one example, a user may desire a “brute force” strategy, in which the RL agent completes the game in the shortest time possible. A “brute force” strategy and associated metas may be desired by a user attempting a speed run through a game. In another example, the desired strategy may be to level-up a character or discover in-game lore quickly, without regard for the pace of completion.

The following illustrative example of a use of the method is provided for a single-player adventure game involving a difficult challenge, such as a boss fight. In preferred embodiments, the RL agent plays the game by opting for various actions within the scenario, such as attacks and defenses during the boss fight. In addition to attacks and defenses, the agent tests various “boost” options, such as armor or equipment upgrades and special moves, any of which are considered actions within the game scenario.

In some embodiments, the RL agent initially takes a randomized approach, randomly selecting actions within the boss fight. The RL agent is rewarded during the course of the boss fight for successful attacks and dodges and is disincentivized for missed attacks and hit points or reduced health points taken by the player character. In some embodiments, the RL agent receives a reward commensurate with damage done against the enemy or magnitude of damage evaded by the player character. In further embodiments, the RL agent is rewarded more greatly for taking a successful action in the boss fight that is previously unknown or under-known, such as equipping a specific weapon-and-armor combination to boost attack or resist the enemy, or performing a sequence of actions that amount to a special attack.

It should be noted that the reward system can be configured to reward actions that conflict with ordinary heuristics such as health points or hit points. For example, in some embodiments, the reward framework is configured to reward the RL agent for reaching low levels of health and still winning a boss fight or completing an objective. In such a case, the reward may be due to popularity of a new move that has been discovered or may be due to a surprise or shock score arising from victory against the odds. As noted, in preferred embodiments, the reward is multidimensional, and generally the reward framework includes both of these metrics as well as others.

In preferred embodiments, the RL agent determines various approaches optimized for various purposes. For example, use of a special move may have been previously unknown to a community and thus may score well for novelty. Similarly, use of a combination of weapon and armor may yield an unexpected and visually spectacular result, thus scoring well for surprise, shock value, and enjoyment.

In a further example, consider a game in which a goal is to build a society comprising villages and armies. The RL agent is rewarded in one of many ways—for instance, the RL agent may be configured to find an optimal method for completing the game while focusing primarily on building villages, then raising armies, then attacking neighboring societies, in this respective order or as closely to it as possible. Alternatively, the RL agent may be configured to complete the game using a more balanced approach, building villages and raising armies concomitantly.

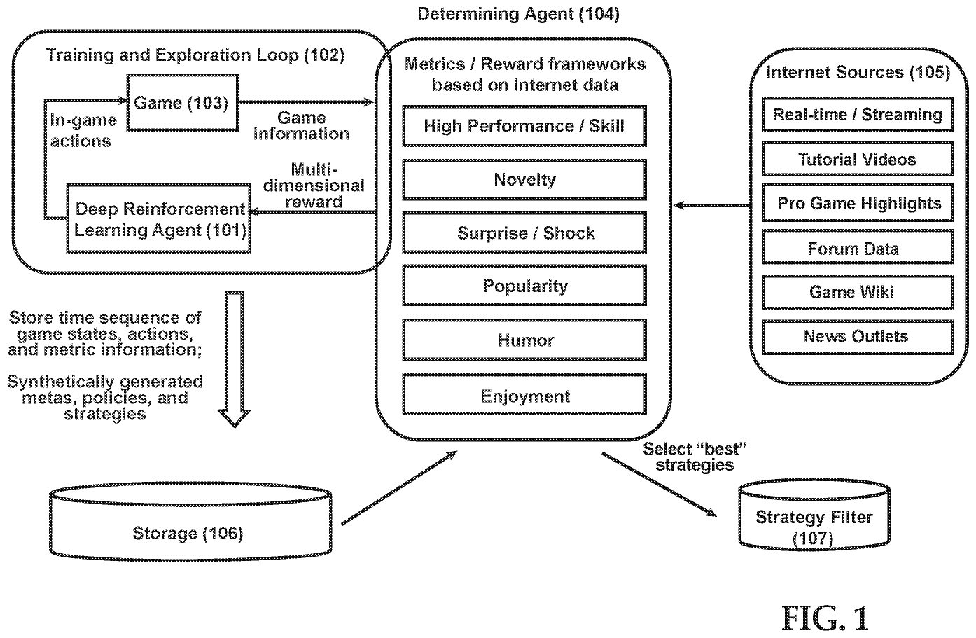

FIG. 1 diagrammatically illustrates an exemplary method for implementing an RL agent to discover metas, policies, and strategies. A deep reinforcement learning agent 101 uses a training and exploration loop 102 to take actions within a game scenario 103. The actions included generally correspond to button control commands, such as “move left” or “jump”, although the in-game actions themselves are not dependent on their trigger conditions. Voice commands, gesture recognition, and other trigger conditions are enabled for in-game actions.

Game information including metas, strategies, and policies obtained by the deep reinforcement learning agent 101 are returned to a determining agent 104. The determining agent 104 receives the data from the deep reinforcement learning agent 101 and further searches, scrapes, and receives data from various Internet sources 105, including real-time streaming platforms, tutorial videos and professional highlights on live video and playback video streaming platforms, real-time online gaming platforms, forum and message board data, game wikis, and news outlets or blogs. In some embodiments, the Internet data is sent and received from the determining agent 104 in real-time and is stored in a buffer, which updates periodically. The received data is used to develop quantitative measures for multi-dimensional evaluation of metas, policies, and strategies. In some embodiments, the quantitative measures are used for guiding further exploration of the game space by the deep reinforcement learning agent 101 and for filtering and sorting for top metas, policies, and strategies. The determining agent 104 obtains the Internet data, evaluates for known metas, and prepares metrics and reward frameworks based on the Internet data. The metrics and reward frameworks are applied to results obtained from the deep reinforcement learning agent 101. By way of an example, a well-known and widely discussed meta, if returned from the deep reinforcement learning agent 101, may score highly for popularity, but not highly for novelty. By contrast, a relatively unknown meta may score well for novelty.

In some embodiments, methods such as image-recognition techniques can be used to determine sudden changes over multiple frames. In such embodiments, sudden changes are used to indicate surprise. In alternative embodiments, surprise, shock, humor, and enjoyment are determined from key words, phrases, and other data recognized from the Internet sources 105.

In some embodiments, the deep reinforcement learning agent 101 stores a time sequence of game state, actions, and metric information in a storage unit 106. The determining agent 104 is configured to receive the stored information from the storage unit 106 and apply the metrics and reward frameworks according to the methods outlined above.

In some embodiments, a strategy filter 106 is applied based on a preferred framework. Using the strategy filter 106, a user may evaluate metas, policies, and strategies by optimal results within one or more frameworks. For example, the user may select the most surprising or most enjoyable metas as determined by the deep reinforcement learning agent 101.

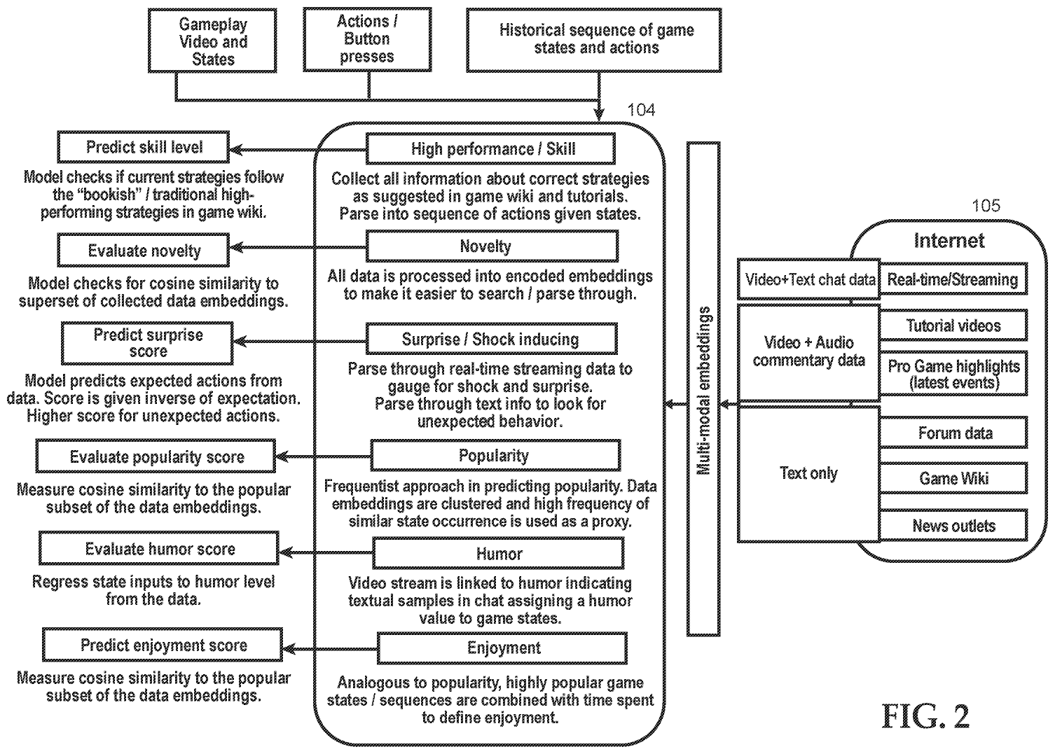

FIG. 2 shows an exemplary method of configuring metrics for a reward model based on Internet data. As noted, the determining agent 104 searches, scrapes, and receives data from various Internet sources 105. The Internet sources 105 generally include real-time gaming and live streaming of games; tutorial videos; professional highlights; forum data; game wikis; and news outlets. The Internet data is received as video and text chat data; video or audio commentary data; or as text data. Multimodal embeddings are used to generate multidimensional vectors that include the video, image, and text data. Embedding vectors are then used for content classification for the videos, images, and text received.

The determining agent 104 further receives data from the deep reinforcement learning agent 101 including: gameplay video and states; actions by the deep reinforcement learning agent (“button presses”); and the historical sequence of game states and actions.

In the exemplary embodiment shown in FIG. 2, the determining agent 104 evaluates standards for metrics based on performance level or skill; novelty; surprise or shock value; popularity; humor; and enjoyment.

To construct a reward framework for performance level or skill, the determining agent collects information about correct strategies as suggested in the Internet data—for example, game wikis and tutorials. The collected data is parsed into one or more sequences of action-given states.

The determining agent checks if the current strategies employed by the deep reinforcement learning agent 101 follow the traditional approach, or “bookish” approach of high-performing strategies, such as those found in a game wiki.

To construct a reward framework for novelty, the Internet data is processed into encoded embeddings for ease of parsing and searching. The model then checks for cosine similarity to the superset of collected data embeddings.

It should be noted that, as used herein, cosine similarity generally refers to a measure of similarity between two nonzero vectors defined in an inner product space—in particular, the similarity of the direction of each vector. Cosine similarity is generally the cosine of the angle between two vectors. In some embodiments of the present disclosure, words, phrases, and other elements are each assigned a different coordinate, and a body of information containing the words, phrases and other elements is represented by the vector of the numbers of occurrences of each word, phrase, or element. Cosine similarity is used to determine how similar a dataset or superset from the deep reinforcement learning agent 101 is to that of a dataset from one or more Internet sources 105.

To construct a reward framework for surprise or shock value, the determining agent 104 parses through Internet data such as real-time streaming data and text for expected behavior. The determining agent then prepares a prediction of expected actions from the data and a score related to the inverse of the expected actions. In some embodiments, the deep reinforcement learning agent 101 is rewarded with a higher score for unexpected actions based on the predicted actions and inverse. In some embodiments, cosine similarity is used to determine a deviation from a set or sequence of expected actions.

To construct a reward framework for popularity, in some embodiments, a frequentist approach is employed in which probability of an event is treated as the equivalent of frequency with which the event has occurred within a sample of data. Data embeddings from the Internet data are clustered, and high frequencies of similar state occurrences are used as proxies for the popularity of an action in a given state. Accordingly, a subset of “popular” actions for given states is created. The popularity score is evaluated using cosine similarity to the subset of popular actions for given states.

To construct a reward framework for humor, in some embodiments, a video stream is linked to humor-indicating textual samples in chat interfaces. The determining agent assigns a humor value according to the textual samples. Textual samples indicating humor may include emojis, gifs, or icons depicting laughter, as well as plain text statements such as “haha”, “lol”, and similar expressions.

In some embodiments, cosine similarity is used to evaluate for humor. In further embodiments, the humor score received by the deep reinforcement learning agent 101 is determined by regression analysis of state inputs received from the deep reinforcement learning agent 101 and compared with the video stream data.

To construct a reward framework for enjoyment, in exemplary embodiments, popular game states and sequences are combined with measures of time spent playing a game in one game state or subsequent game states. The combination of popular game states and time spent are used to define one or more variables for determining enjoyment. The predicted enjoyment score can be measured using the cosine similarity for the popular subset of data embeddings as well as a subset of time data.

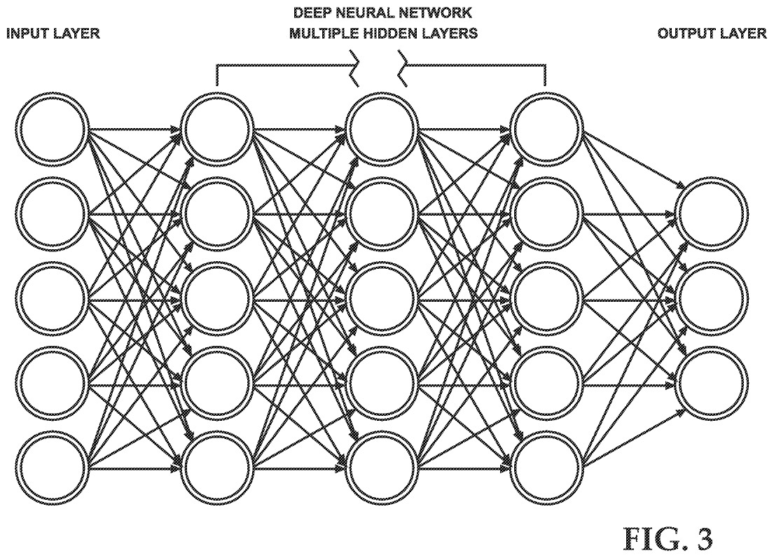

FIG. 3 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. This process of passing data from one layer to the next layer defines this neural network as a feedforward network. Larger weights signify that particular variables are of greater importance to the decision or outcome.

According to some exemplary embodiments, deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

With respect to FIG. 2, according to some exemplary embodiments, the system produces an output, which in turn produces an outcome, which in turn produces an input. In some embodiments, the output may become the input.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A system for discovering at least one new technique for playing a game, the system comprising:
a determining agent comprising at least one processor and at least one memory storing instructions which, when executed by the at least one processor, cause the processor to:
search at least one Internet platform for data related to at least one game scenario; and
determine at least one reward framework based on results from the search of the at least one Internet platform, the at least one reward framework being determined by at least one metric for a characteristic of the at least one game scenario; and
a reinforcement learning agent configured to perform a training and exploration loop comprising a plurality of iterations, each of the plurality of iterations comprising:
playing the at least one game scenario within a game, the playing comprising taking a plurality of sequential in-game actions available in the at least one game scenario;
transmitting results of each of the plurality of sequential in-game actions to the determining agent; and
receiving a reward for successful progression through the at least one game scenario according to at least one reward framework determined by the determining agent, the reward comprising a quantitative score.

2. The system of claim 1, the determining agent being further configured to determine an optimal sequence of in-game actions for the at least one game scenario based on a plurality of scores comprising each of the quantitative scores from each of the plurality of iterations.

3. The system of claim 1, the at least one Internet platform comprising any one of: a video streaming platform, a game developer website, an Internet forum, a game wiki, and a news source.

4. The system of claim 1, the characteristic of the at least one game scenario being any one of: level of difficulty or skill of the at least one game scenario; novelty of the in-game action or the sequence of actions; surprise due to a result of the action or the sequence of actions; popularity of the in-game action or sequence of actions; humor due to the result of the action or the sequence of actions; and enjoyment of the result of the action or sequence of actions.

5. The system of claim 1, the at least one metric for the characteristic being any one of: frequency of a key word or phrase associated with the at least one in-game scenario; image data from image stills or video frames associated with the at least one in-game scenario; a trendline indicating a change in the frequency with which the key word or phrase are used; and game data from networked games indicating the frequency with which the action or the sequence of actions are used in the in-game scenario.

6. The system of claim 1, further comprising a memory storage for storing a sequence of game states, the actions and the sequence of actions, and information associated with the metrics for the at least one characteristic of the in-game scenario.

7. The system of claim 1, further comprising a filtering agent configured to determine optimal metas, policies, and strategies for the in-game actions as defined by the at least one metric for the characteristic.

8. The system of claim 1, the determining agent further comprising a deep neural network having an input layer, a plurality of hidden layers, and an output layer, the plurality of hidden layers being configured to process input received at the input layer and transmit a first output to the output layer, the plurality of hidden layers being trained and tuned using weights and biases for optimal results based on the at least one metric for the characteristic.

9. The system of claim 1, the determining agent being further configured to share results from the plurality of iterations with a network of users and evaluate subsequent trends related to the results.

10. A method for configuring a reinforcement learning system for discovering at least one new technique for playing a game, the method comprising:
configuring a determining agent comprising at least one processor and at least one memory with instructions which, when executed by the at least one processor, cause the processor to:
search at least one Internet platform for data related to at least one game scenario; and
determine at least one reward framework based on results from the search of the at least one Internet platform, the at least one reward framework being determined by at least one metric for a characteristic of the at least one game scenario; and
configuring a reinforcement learning agent to perform a training and exploration loop comprising a plurality of iterations, each of the plurality of iterations comprising:
playing the at least one game scenario within a game, the playing comprising taking a plurality of sequential in-game actions available in the at least one game scenario;
transmitting results of each of the plurality of sequential in-game actions to the determining agent; and
receiving a reward for successful progression through the at least one game scenario according to at least one reward framework determined by the determining agent, the reward comprising a quantitative score.

11. The method of claim 10, the configuring of the determining agent further comprising instructions to determine an optimal sequence of in-game actions for the at least one game scenario based on a plurality of scores comprising each of the quantitative scores from each of the plurality of iterations.

12. The method of claim 10, the at least one Internet platform comprising any one of: a video streaming platform, a game developer website, an Internet forum, a game wiki, and a news source.

13. The method of claim 10, the characteristic of the at least one game scenario being any one of: level of difficulty or skill of the at least one game scenario; novelty of the in-game action or the sequence of actions; surprise due to a result of the action or the sequence of actions; popularity of the in-game action or sequence of actions; humor due to the result of the action or the sequence of actions; and enjoyment of the result of the action or sequence of actions.

14. The method of claim 10, the at least one metric for the characteristic being any one of: frequency of a key word or phrase associated with the at least one in-game scenario; image data from image stills or video frames associated with the at least one in-game scenario; a trendline indicating a change in the frequency with which the key word or phrase are used; and game data from networked games indicating the frequency with which the action or the sequence of actions are used in the in-game scenario.

15. The method of claim 10, further comprising storing a sequence of game states, the actions and the sequence of actions, and information associated with the metrics for the at least one characteristic of the in-game scenario in a memory storage.

16. The method of claim 10, further comprising implementing a filtering agent configured to determine optimal metas, policies, and strategies for the in-game actions as defined by the at least one metric for the characteristic.

17. The method of claim 10, the determining agent further comprising a deep neural network having an input layer, a plurality of hidden layers, and an output layer, the plurality of hidden layers being configured to process input received at the input layer and transmit a first output to the output layer, the plurality of hidden layers being trained and tuned using weights and biases for optimal results based on the at least one metric for the characteristic.

18. The method of claim 10, the determining agent being further configured to share results from the plurality of iterations with a network of users and evaluate subsequent trends related to the results.

19. A method for discovering at least one new technique for playing a game, the method comprising:
implementing a determining agent comprising at least one processor and at least one memory storing instructions which, when executed by the at least one processor, cause the processor to execute a method comprising:
searching at least one Internet platform for data related to at least one game scenario;
determining at least one reward framework based on results from the search of the at least one Internet platform, the at least one reward framework being determined by at least one metric for a characteristic of the at least one game scenario; and
determining an optimal sequence of in-game actions for the at least one game scenario based on a plurality of scores comprising each of the quantitative scores from each of the plurality of iterations; and
implementing a reinforcement learning agent configured to perform a training and exploration loop comprising a plurality of iterations, each of the plurality of iterations comprising:
playing the at least one game scenario within a game, the playing comprising taking a plurality of sequential in-game actions available in the at least one game scenario;
transmitting results of each of the plurality of sequential in-game actions to the determining agent; and
receiving a reward for successful progression through the game scenario according to at least one reward framework determined by the determining agent, the reward comprising a quantitative score.

20. The method of claim 19, further comprising the determining agent sharing results from the plurality of iterations with a network of users and evaluating subsequent trends related to the results.
